(19) United States
(12) Patent Application Publication
(10) Pub. No.: US 2008/0098139 A1
(43) Pub. Date: Apr. 24, 2008

(54) HIGH SPEED DATA TRANSMISSION SYSTEM AND METHOD

(75) Inventors: Chia-Chun Lien, Taipei (TW); Yu-Tin Hsu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/675,708

(22) Filed: Feb. 16, 2007

(30) Foreign Application Priority Data
Oct. 24, 2006 (TW) 95139154

(51) Int. Cl. G06F 13/00

(52) U.S. Cl. 710/100

(57) ABSTRACT

A high speed transmission system comprises a host controller with a host logic unit and a device controller with a device logic unit. The host controller transmits and receives a digital signal through the first interface according to the first descriptor in a memory. The device controller transmits and receives the digital signal through the second interface according to the second descriptor in the memory.

### BACKGROUND OF THE INVENTION

1. Field of the Invention

The invention relates to high speed transmission, and in particular to a high speed transmission system with no physical access level.

2. Description of the Related Art

FIG. 1 is a schematic diagram of conventional single chip system 110 connected to USB (universal serial bus) card reader 150. Single chip system 110 comprises CPU 120, system memory 130, and USB host controller. USB card reader 150 comprises CPU 180, memory 170, USB device controller 160 and memory controller 190. USB host controller 140 further comprises USB host logic unit 142, USB UTMI (USB Transceiver Macrocell Interface) logic unit 144 and USB host PHY (Physical Access Level) 146. USB device controller 160 further comprises USB device logic unit 162, USB UTMI logic unit 164 and USB device PHY 166.

USB host controller 140 and USB device controller 160 respectively use USB host PHY 146 and USB device PHY 166 for transmission and reception of data, comprising one bit analog transmission at a maximum speed of 480 Mb/sec. In conventional architecture, at least two CPUs 120 and 180, two memories 130 and 170, USB host controller 140 with USB host PHY 146, USB device controller 160 with USB device PHY 166 and memory controller 190 are employed accessing data of memory card 155. A reduction in the number of required devices is thus desirable.

### BRIEF SUMMARY OF THE INVENTION

A detailed description is given in the following embodiments with reference to the accompanying drawings.

The invention provides a high speed transmission system comprising a host controller with a host logic unit transmitting and receiving a digital signal through a first interface according to a first descriptor in a memory and a device controller with a device logic unit transmitting and receiving the digital signal through a second interface according to a second descriptor in the memory.

The invention provides a high speed transmission system comprising a host controller transmitting and receiving a digital signal through a first interface according to a first descriptor, a device controller transmitting and receiving the digital signal through a second interface according to a second descriptor, a peripheral device controller accessing data of a peripheral device and a memory accessing data of the peripheral device, the host controller and the device controller, and respectively providing the first descriptor and the second descriptor to the host controller and the device controller.

The invention provides a high speed data transmission method comprising reading first data of a memory and transmitting the first data to a device controller by a host controller according to a first descriptor of the memory, transmitting the first data to the memory by a device controller according to a second descriptor of the memory and reading the first data of the second part of the memory by a peripheral device controller according to a first command of a CPU.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional single chip system connected to a USB card reader;

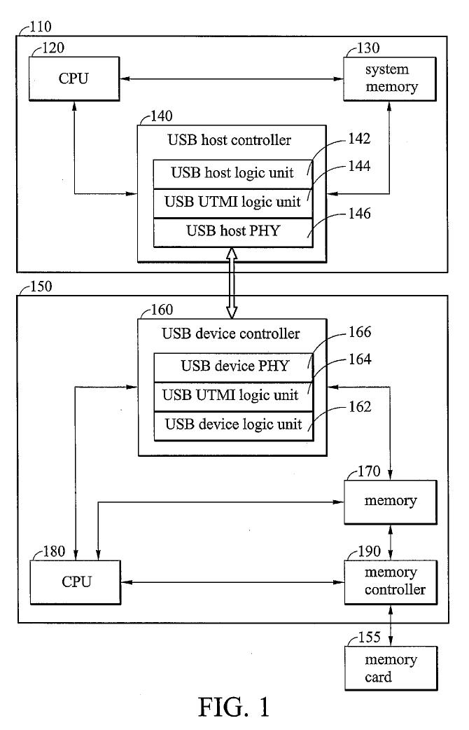

FIG. 2 is a schematic diagram of a high speed transmission system according to an embodiment of the invention;

FIG. 3 is a flowchart of a high speed data transmission method according to an embodiment of the invention; and

FIG. 4 is a flowchart of a high speed data transmission method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

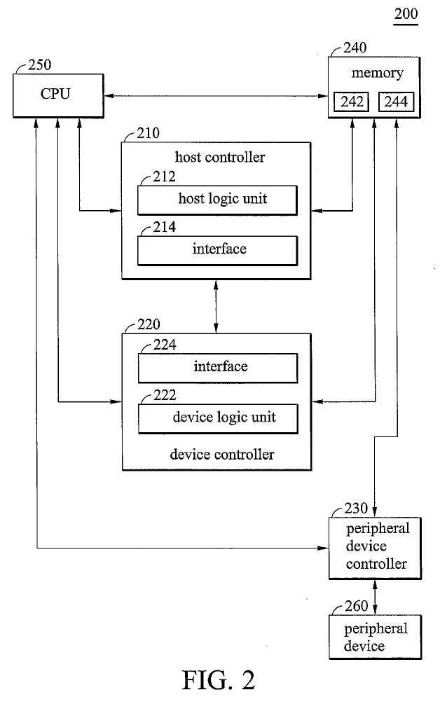

FIG. 2 is a schematic diagram of high speed transmission system 200 according to an embodiment of the invention. High speed transmission system 200 comprises host controller 210, device controller 220, peripheral device controller 230, memory 240, CPU 250 and peripheral device 260. Host controller 210 further comprises host logic unit 212 and interface 214. Device controller 220 further comprises device logic unit 222 and interface 224. Memory 240 further comprises first part memory 242 and second part memory 244. As an example, host controller 210 can be a USB host controller, host logic unit 212 can be a USB host logic unit, device controller 220 can be a USB device controller, device logic unit can be a USB device logic unit and interfaces 214 and 224 can be UTMI interfaces transmitting 8-bit digital data at 60 MHz.

FIG. 2 shows high speed transmission system 200 transmitting data to peripheral device 260 according to an embodiment of the invention. High speed transmission system 200 retrieves data from non-volatile memory (such as a hard disk, a floppy disk or a magnetic tape, not shown in FIG. 2) to store the data in first part memory 242 of memory 240. CPU 250 respectively transmits descriptors to first part memory 242 and second part memory 244. Host controller 210 reads data from first part memory 242 according to the descriptor stored in first part memory 242 and uses UTMI interfaces 214 and 224 to transmit data to device controller 220 (UTMI interface is an 8-bit, 60 MHz digital transmission interface). Device controller 220 transmits data to second part memory 244 according to the descriptor stored in second part memory 244. Peripheral device controller 230 reads data of second part memory 244 and transmits the data to peripheral device 260 according to the command from CPU 250. In addition, host controller 210 can transmit an interrupted signal to CPU 250, and CPU will temporarily interrupt the current job and control host controller 210 by accessing registers of host controller 210. Similarly, device controller 220 also can transmit an interrupted signal to CPU 250, CPU 250 will temporarily interrupt the current job and control device controller 220 by accessing registers of control device controller 220.

In addition, FIG. 2 further shows high speed transmission system 200 receiving data from peripheral device 260 according to another embodiment of the invention. CPU 250 respectively transmits descriptors to first part memory 242 and second part memory 244. Peripheral device controller 230 transmits data to second part memory 244 according to the command from CPU 250. Device controller 220 reads data from second part memory 244 according to the descriptor stored in second part memory 244 and transmits the data through UTMI interfaces 224 and 214 to host controller 210. Host controller 210 transmits the data to first part memory 242 according to the descriptor stored in first part memory 242. High speed transmission system 20 also can store data of first part memory in a non-volatile memory.

The high speed transmission system can be used in memory card reading. For example, peripheral device controller 230 can be a memory card controller and peripheral device 260 can be a memory card, such as SD (Secure Digital) memory card, MS (Memory Stick) memory card, SM (SmartMedia) memory card, CF (Compact Flash) memory card and so on . . .

In addition, the high speed transmission system can be used in SATA (Serial Advances Technology Attachment). Host controller 210 can be a SATA host controller, host logic unit 212 can be a SATA host logic unit, device controller 220 can be a SATA device controller and device logic unit 222 can be a SATA device logic unit.

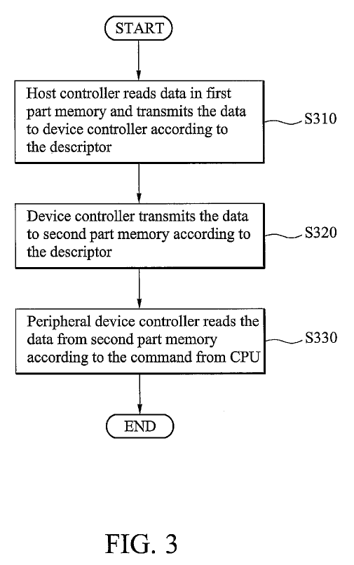

FIG. 3 is a flowchart of a high speed data transmission method according to an embodiment of the invention. Host controller 210 reads the first data in first part memory 242 and transmits the first data to device controller 220 according to the descriptor stored in first part memory 242 (step S310). Device controller 220 transmits the first data to second part memory 244 according to the descriptor stored in second part memory 244 (step S320). Peripheral device controller 230 reads the first data from second part memory 244 according to the command from CPU 250 (step S330).

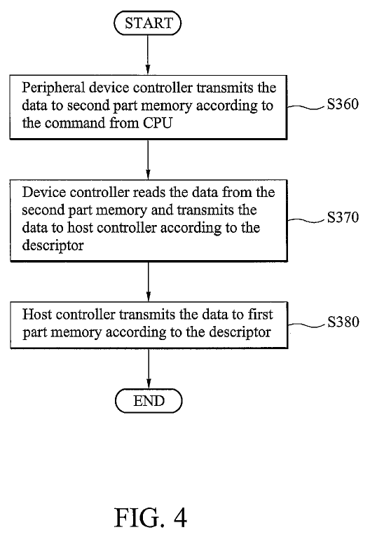

FIG. 4 is a flowchart of a high speed data transmission method according to another embodiment of the invention. Peripheral device controller 230 transmits the second data to second part memory 244 according to the command from CPU 250 (step S360). Device controller 220 reads the second data from the second part memory 244 and transmits the second data to host controller 210 according to the descriptor stored in second part memory 244 (step S370). Host controller 210 transmits the second data to first part memory 242 according to the descriptor stored in first part memory 242 (step S380).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A high speed transmission system, comprising:
a host controller with a host logic unit transmitting and receiving a digital signal through a first interface according to a first descriptor in a memory; and
a device controller with a device logic unit transmitting and receiving the digital signal through a second interface according to a second descriptor in the memory.

2. The high speed transmission system as claimed in claim 1, wherein the host controller is a USB host controller, the device controller is a USB device controller, the host logic unit is a USB host logic unit and the device logic unit is a USB device logic unit.

3. The high speed transmission system as claimed in claim 1, wherein the host controller is a SATA host controller, the device controller is a SATA device controller, the host logic unit is a SATA host logic unit and the device logic unit is a SATA device logic unit.

4. The high speed transmission system as claimed in claim 1, wherein the first interface and the second interface are UTMI interfaces.

5. The high speed transmission system as claimed in claim 1, wherein the first interface and the second interface digitally transmit 8-bit data at 60 MHz.

6. A high speed transmission system, comprising:
a host controller transmitting and receiving a digital signal through a first interface according to a first descriptor;
a device controller transmitting and receiving the digital signal through a second interface according to a second descriptor;
a peripheral device controller accessing data of a peripheral device; and
a memory accessing data of the peripheral device, the host controller and the device controller, and respectively providing the first descriptor and the second descriptor to the host controller and the device controller.

7. The high speed transmission system as claimed in claim 6, further comprising:
a CPU providing the first descriptor and the second descriptor to the memory, and controlling the peripheral device to access data of the memory and the peripheral device.

8. The high speed transmission system as claimed in claim 6, wherein the host controller further comprises a host logic unit and the device controller further comprises a device logic unit.

9. The high speed transmission system as claimed in claim 8, wherein the host controller is a USB host controller, the device controller is a USB device controller, the host logic unit is a USB host logic unit and the device logic unit is a USB device logic unit.

10. The high speed transmission system as claimed in claim 8, wherein the host controller is a SATA host controller, the device controller is a SATA device controller, the host logic unit is a SATA host logic unit and the device logic unit is a SATA device logic unit.

11. The high speed transmission system as claimed in claim 6, wherein the first interface and the second interface are UTMI interfaces.

12. The high speed transmission system as claimed in claim 6, wherein the first interface and the second interface digitally transmit 8-bit data at 60 MHz.

13. The high speed transmission system as claimed in claim 6, wherein the memory further comprises a first part memory accessing the first descriptor and a second part memory accessing the second descriptor.

14. A high speed data transmission method, comprising:
reading first data of a memory and transmitting the first data to a device controller by a host controller according to a first descriptor of the memory;
transmitting the first data to the memory by a device controller according to a second descriptor of the memory; and
reading the first data of the memory by a peripheral device controller according to a first command of a CPU.

15. The high speed data transmission method as claimed in claim 14, further comprising:
transmitting second data by the peripheral device to the memory according to a second command of the CPU;
reading the second data of the memory and transmitting the second data to the host controller by the device controller according to a third descriptor of the memory; and
transmitting the second data to the memory by the host controller according to a fourth descriptor of the memory.

16. The high speed data transmission method as claimed in claim 14, wherein the host controller further comprises a host logic unit and the device controller further comprises a device logic unit.

17. The high speed data transmission method as claimed in claim 16, wherein the host controller is a USB host controller, the device controller is a USB device controller, the host logic unit is a USB host logic unit and the device logic unit is a USB device logic unit.

18. The high speed data transmission method as claimed in claim 16, wherein the host controller and the device controller respectively comprise UTMI interfaces.

19. The high speed data transmission method as claimed in claim 18, wherein the UTMI interface digitally transmits 8-bit data at 60 MHz.
